(19) United States
(12) Patent Application Publication
(10) Pub. No.: US 2025/0102834 A1
(43) Pub. Date: Mar. 27, 2025

(54) INDIUM TIN OXIDE REFLECTION CONTROL

(71) Applicant: HOYA Optical Labs Of America, Inc., Lewisville, TX (US)

(72) Inventors: Jeffrey Brown, St. Louis Park, MN (US); Michael Marshall, Andover, MN (US)

(73) Assignee: HOYA Optical Labs Of America, Inc., Lewisville, TX (US)

(21) Appl. No.: 18/893,680

(22) Filed: Sep. 23, 2024

Related U.S. Application Data
(60) Provisional application No. 63/626,819, filed on Jan. 30, 2024.
(60) Provisional application No. 63/584,824, filed on Sep. 22, 2023.

(51) Int. Cl. G02C 7/08

(52) U.S. Cl. CPC G02C 7/083

(57) ABSTRACT

An electronic device, such as an electrochromic ophthalmic lens, having at least one iridium tin oxide layer, at least one polycarbonate layer, and one or more additional layers between the iridium tin oxide and polycarbonate layers to act as an antireflective or index matching layer. The one or more additional layers may include one or more of silicone dioxide, zirconium dioxide, and/or iridium tin oxide.

### RELATED APPLICATIONS

This application claims benefit of and priority to U.S. Patent Application Ser. No. 63/584,824 filed Sep. 22, 2023 and entitled Indium Tin Oxide Reflection Control and U.S. Patent Application Ser. No. 63/626,819 filed Jan. 30, 2024 and entitled Indium Tin Oxide Reflection Control, both of which are hereby incorporated herein by reference in their entireties.

### BACKGROUND OF THE INVENTION

Indium Tin Oxide (“ITO”) is a transparent conductive coating which is used in many electronic devices which benefit from a transparent electrode material, such as electrochromic devices, electro-photochromic devices, smart lenses, and the like.

ITO has a refractive index which is between about 1.8 and 2.0. In device structures, ITO is commonly embedded as a sheet in a laminate under a polymeric film material such as polycarbonate. This sheet is then laminated to another sheet of similar construction. As a result, the ITO is embedded in the electronic device and surrounded by materials having different refractive indexes, which can result in higher-than-desired reflection.

A typical structure, such as that used in various electrochromic devices, may have an average reflection of 5.7% over the visible spectrum (400 nm-700 nm). This average reflection can be lowered to 2.4% by increasing the thickness of the ITO sheet, such as from 100 nm to 130 nm, to position the minimum reflectance more centrally in the device. However, increasing the thickness of the ITO sheet may increase the risk of cracking of the ITO when forming curved surfaces, such as is typical in ophthalmic lenses.

Accordingly, there is a need for a system and/or method for reducing reflectance in an electronic device such as an ophthalmic lens without substantially increasing the thickness of any ITO layer or sheet.

### SUMMARY OF THE INVENTION

Disclosed herein are systems, devices, and/or methods which utilize one or more additional layers to lower the reflectance in electronic devices having an ITO sheet or layer.

In an example, one or more additional layers may be incorporated between polycarbonate and ITO layers of an electronic device to act as an antireflective or index matching layer(s).

In an example, one or more layers may be added between a buffer layer and an ITO layer to reduce the reflection to about 1.5%.

In an example, a pair of such layers may comprise zirconium dioxide having a thickness of about 14 nm and silicone dioxide having a thickness of about 28 nm.

In an example, the ITO layer may comprise a thickness of about 130 nm and utilized as a high index material in the coating design.

In an example, the incorporation of metal oxide or organic material layers which are less prone to cracking during formation into curved surfaces, thereby giving greater design freedom and improved performance.

In an example, an electronic device may comprise the following layers: a first polycarbonate layer, a first buffer layer, a first ITO layer, one or more electrochromic layers, a second ITO layer, a second buffer layer, and a second polycarbonate layer.

In an example, one or both of the ITO layers may comprise a thickness of between about 100 nm and 130 nm and an index of about 1.9.

In an example, one or both of the buffer layers may comprise a thickness of about 3000 nm and an index of about 1.5.

In an example, one or both polycarbonate layers may comprise an index of about 1.59.

In an example, the one or more electrochromic layers may comprise an index of about 1.5.

In an example, one or both of the buffer layers may comprise a siloxane hardcoat.

In an example, an electronic device may comprise the following layers: a first polycarbonate layer, a first buffer layer, a first AR structure, a first ITO layer, one or more electrochromic layers, a second ITO layer, a second AR structure, a second buffer layer, and a second polycarbonate layer.

In an example, one or both of the AR structures may comprise an AR stack including one or more of the following materials: zirconium dioxide and/or silicone dioxide.

In some aspects, the techniques described herein relate to an electronic ophthalmic lens, including: a first polycarbonate layer; a second polycarbonate layer; an electrochromic layer between the first polycarbonate layer and the second polycarbonate layer; a first ITO layer between the first polycarbonate layer and the electrochromic layer; and a first AR layer between the first polycarbonate layer and the first ITO layer.

In some aspects, the techniques described herein relate to an electronic ophthalmic lens, wherein the first AR layer includes silicone dioxide.

In some aspects, the techniques described herein relate to an electronic ophthalmic lens, wherein the first AR layer includes zirconium dioxide.

In some aspects, the techniques described herein relate to an electronic ophthalmic lens, wherein the first AR layer has a thickness which is less than a thickness of the first ITO layer.

In some aspects, the techniques described herein relate to an electronic ophthalmic lens, wherein a thickness of the first ITO layer is between 100 nm and 130 nm.

In some aspects, the techniques described herein relate to an electronic ophthalmic lens, further including a second ITO layer between the second polycarbonate layer and the electrochromic layer.

In some aspects, the techniques described herein relate to an electronic ophthalmic lens, further including a second AR layer between the second polycarbonate layer and the second ITO layer.

In some aspects, the techniques described herein relate to an electronic ophthalmic lens, wherein the first AR layer and the second AR layer each include silicone dioxide and zirconium dioxide.

In some aspects, the techniques described herein relate to an electronic ophthalmic lens, further including a first buffer layer between the first polycarbonate layer and the first ITO layer and a second buffer layer between the second polycarbonate layer and the second ITO layer.

In some aspects, the techniques described herein relate to an electronic ophthalmic lens, wherein the first buffer layer and the second buffer layer are each included of a siloxane hardcoat.

In some aspects, the techniques described herein relate to an electronic ophthalmic lens, wherein the first AR layer includes a first silicone dioxide layer, a second silicone dioxide layer, and a zirconium dioxide layer between the first and second silicone dioxide layers.

In some aspects, the techniques described herein relate to an electronic ophthalmic lens, wherein the first AR layer includes alternating layers of silicone dioxide and zirconium dioxide.

In some aspects, the techniques described herein relate to an electronic ophthalmic lens, including: a first polycarbonate layer; a second polycarbonate layer; an electrochromic layer between the first polycarbonate layer and the second polycarbonate layer; a first ITO layer between the first polycarbonate layer and the electrochromic layer; a first AR layer between the first polycarbonate layer and the first ITO layer; a second ITO layer between the second polycarbonate layer and the electrochromic layer; and a second AR layer between the second polycarbonate layer and the second ITO layer.

In some aspects, the techniques described herein relate to an electronic ophthalmic lens, further including a first buffer layer between the first AR layer and the first polycarbonate layer.

In some aspects, the techniques described herein relate to an electronic ophthalmic lens, further including a second buffer layer between the second AR layer and the second polycarbonate layer.

In some aspects, the techniques described herein relate to an electronic ophthalmic lens, wherein each of the first and second buffers layers includes a siloxane hardcoat.

In some aspects, the techniques described herein relate to an electronic ophthalmic lens, wherein the first ITO layer and the second ITO layer each include silicone dioxide.

In some aspects, the techniques described herein relate to an electronic ophthalmic lens, wherein the first ITO layer and the second ITO layer each include zirconium dioxide.

In some aspects, the techniques described herein relate to an electronic ophthalmic lens, wherein the first ITO layer and the second ITO layer each include alternating layers of silicone dioxide and zirconium dioxide.

In some aspects, the techniques described herein relate to an electronic ophthalmic lens, wherein the first ITO layer and the second ITO layer each include a first silicone dioxide layer, a second silicone dioxide layer, and a zirconium dioxide layer between the first and second silicone dioxide layers.

### BRIEF DESCRIPTION OF THE DRAWINGS

These and other aspects, features and advantages of which embodiments of the invention are capable of will be apparent and elucidated from the following description of embodiments of the present invention, reference being made to the accompanying drawings, in which

FIG. 1A is a diagram and table illustrating layering and reflection values in accordance with an example.

FIG. 1B is a graph illustrating layering and reflection values in accordance with an example.

FIG. 1C is a series of graphs illustrating reflectance of the layers shown in FIG. 1A based on different parameters in accordance with an example.

FIG. 1D is a graph illustrating reflectance of the layers shown in FIG. 1A based on different parameters in accordance with an example.

FIG. 2A is a diagram and table illustrating layering and reflection values in accordance with an example.

FIG. 2B is a graph illustrating layering and reflection values in accordance with an example.

FIG. 3A is a diagram and table illustrating layering and reflection values in accordance with an example.

FIG. 3B is a graph illustrating layering and reflection values in accordance with an example.

FIG. 4A is a diagram and table illustrating layering and reflection values in accordance with an example.

FIG. 4B is a graph illustrating layering and reflection values in accordance with an example.

FIG. 5A is a diagram and table illustrating layering and reflection values in accordance with an example.

FIG. 5B is a graph illustrating layering and reflection values in accordance with an example.

FIG. 6A is a diagram and table illustrating layering and reflection values in accordance with an example.

FIG. 6B is a graph illustrating layering and reflection values in accordance with an example.

FIG. 7A is a diagram and table illustrating layering and reflection values in accordance with an example.

FIG. 7B is a graph illustrating layering and reflection values in accordance with an example.

FIG. 8A is a diagram and table illustrating layering and reflection values in accordance with an example.

FIG. 8B is a graph illustrating layering and reflection values in accordance with an example.

### DETAILED DESCRIPTION

Specific embodiments of the invention will now be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

For the purposes of this specification, use of the terms “about”, “around”, or “approximately” when referring to a value may be understood to mean within 10% of the stated value (either greater or lesser), inclusive.

As mentioned previously, reflectance across the visible spectrum (e.g., between about 400 nm and 700 nm) may be undesirably high in certain electronic devices such as electrochromic lenses, electro-photochromic lenses, smart lenses, and the like which rely on indium tin oxide (ITO) as a transparent conductive coating.

One method of reducing such reflectance is to increase the thickness of the ITO layer in such electronic devices, such as by about 30%. However, increasing the thickness of the ITO layer increases the risk of cracking of the ITO when imparting a curvature such as is common when fabricating various types of optical lenses. An alternate approach, which does not necessarily require an increased thickness of the ITO layer, is to incorporate additional anti-reflective (AR) and/or index matching layers between the polycarbonate and ITO layers in such lenses. Such AR layers and/or index matching layers may include zirconium dioxide (ZrO₂), commonly referred to as “zirconia” and/or silicone dioxide (SiO₂), commonly referred to as “silica”.

Disclosed herein are various examples of an electronic device which may include one or more additional layers to lower the electronic device's reflectance across the visible spectrum. Thus, additional layers may be introduced between polycarbonate and ITO layers of the electronic device to function as antireflective and/or index matching layers. One or more layers may be added between a buffer layer and an ITO layer to reduce the reflectance to between about 1%-2% or, in some examples, to about 1.5%, over the visible spectrum. Such one or more layers may comprise one or more layers of zirconium dioxide and/or silicone dioxide.

A first example of an electronic device may comprise multiple layers, including one or more polycarbonate layers, one or more buffer layers, one or more ITO layers, and one or more electrochromic layers. From bottom to top, the electronic device may comprise a first polycarbonate layer, a first buffer layer, a first ITO layer, one or more electrochromic layers, a second ITO layer, a second buffer layer, and a second polycarbonate layer. In such an example of an electronic device, the thickness of the ITO layers may be increased so as to reduce reflectance across the visible spectrum.

A second example of an electronic device may include the above-stated layers as well as one or more additional anti-reflectance (AR) and/or index matching layers. From bottom to top, such an electronic device may comprise a first polycarbonate layer, a first buffer layer, a first AR structure, a first ITO layer, one or more electrochromic layers, a second ITO layer, a second AR structure, a second buffer layer, and a second polycarbonate layer. In such an example of an electronic device, the thickness of the ITO layers may not need to be increased due to the presence of the additional AR layers while still retaining similar lowered reflectance values across the visible spectrum.

The various layers may comprise various thicknesses. By way of example, a zirconium dioxide layer comprise a thickness of about 14 nm, a silicone dioxide layer may comprise a thickness of about 28 nm, an ITO layer may comprise a thickness of between about 100 nm and 130 nm, and the buffer layer(s) may each comprise a thickness of about 3000 nm. The thickness of any polycarbonate layer(s) may vary widely depending on the device being produced (e.g., the desired ophthalmic lens).

The various layers may also comprise various reflective indexes. By way of example, the ITO layer(s) may each comprise an index of about 1.9, the buffer layer(s) may each comprise an index of about 1.5, the polycarbonate layer(s) may each comprise an index of about 1.59, and the electrochromic layer(s) may comprise an index of about 1.5.

The materials utilized for each of the layers may also vary. The buffer layer may be comprised of a siloxane hardcoat, tungsten bronze, or similar material(s). The AR layer may be comprised of one or more layers of silicone dioxide and/or zirconium dioxide.

The manner by which the layers may be deposited may vary in different examples. As an example, a rugate filter may be formed by various techniques including, e.g., sputtering, chemical vapor deposition, and the like.

In one example, a sample may be moved (e.g., rotationally, pivotably, axially, etc.) so as to pass by at least a deposit zone and a reaction zone. The deposit zone may comprise one or more metallic targets fed by a sputtering gas. The reaction zone may comprise a plasma barrel fed by the same or a different gas. Each zone may be powered separately at different power levels (e.g., wattages) or each zone may be powered by the same power source as the same power level or different power levels.

The metallic targets may comprise, e.g. a silicon target and a zirconium target. Metal may be deposited on the sample at each of the metallic targets. The plasma barrel may then oxidize each metallic layer as the sample passes by. Each of the plasma barrel and targets may be fed by a gas source. In one example, the plasma barrel may be fed by an oxygen source and the metallic targets may be fed by an argon source.

In another example, chemical vapor deposition may be utilized to deposit thin films with a continuously varying refractive index. Chemical vapor deposition may involve the precise control of the chemical composition of gases introduced into a deposition chamber, which may be under vacuum, to produce the continuously varying refractive index.

Specific examples are described below. However, it should be appreciated that any of the features from any of the examples can be mixed and matched with each other in any combination. Hence, the present invention should not be restricted to only these examples, but any broader combination(s) thereof.

The figures generally illustrate different examples of deposited layers which may collectively form the electronic device.

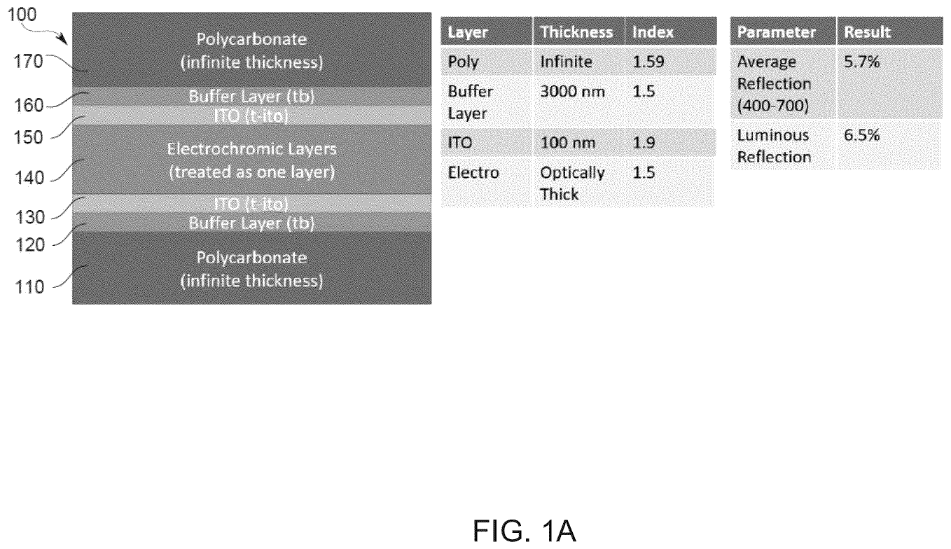

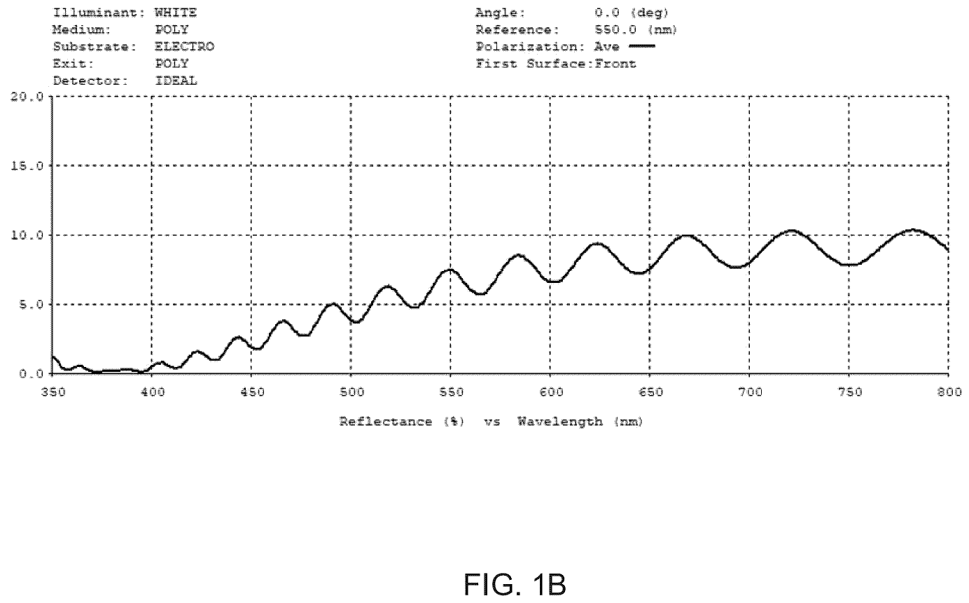

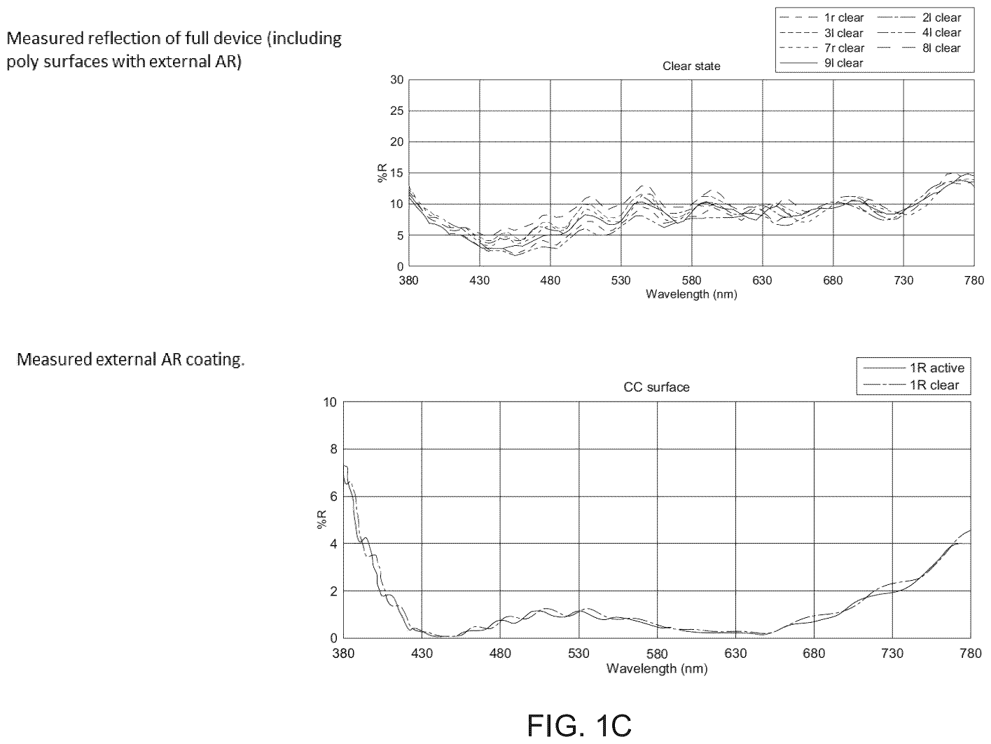

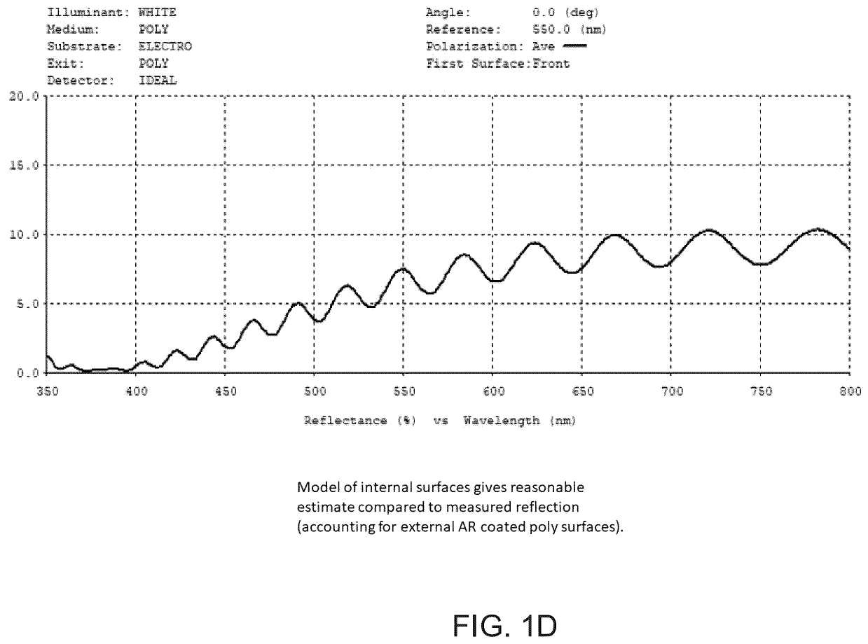

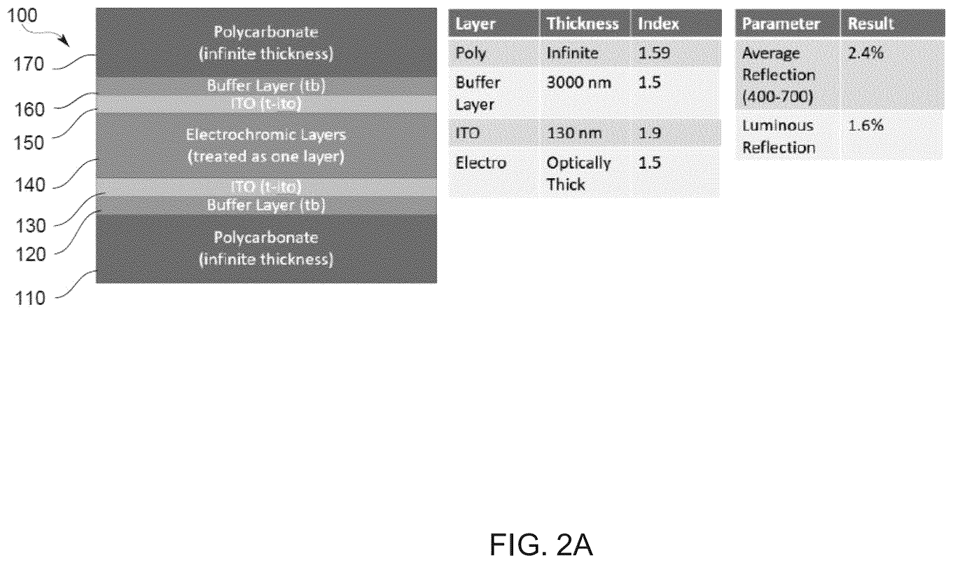

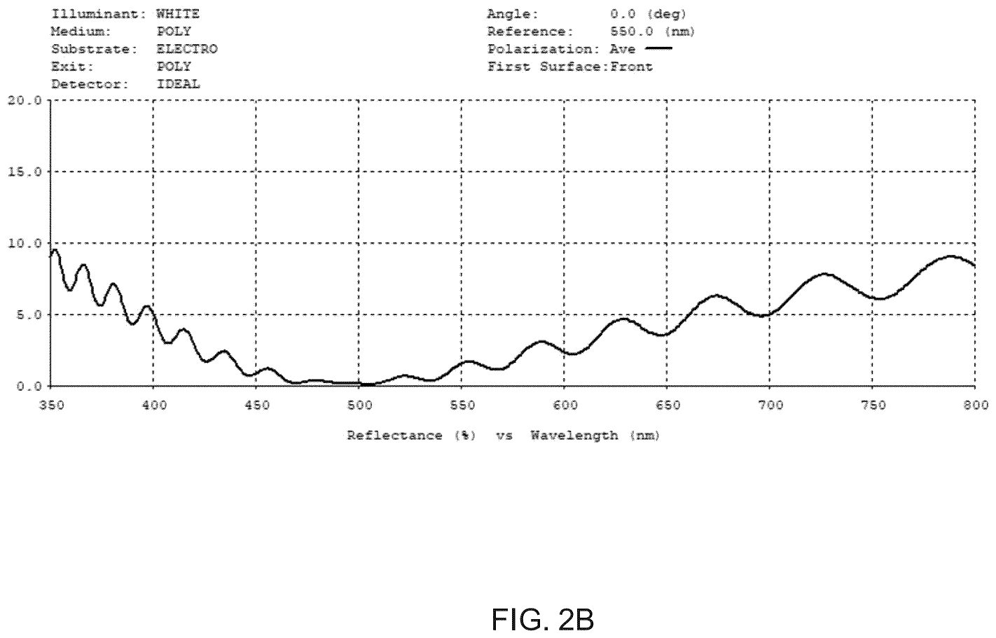

FIGS. 1A and 2A illustrate an example of an electronic device 100 which does not include any additional anti-reflective and/or index matching layers.

In an example as shown in FIG. 1A, an electronic device 100 may comprise, from bottom to top, a first polycarbonate layer 110, a first buffer layer 120, a first ITO layer 130, one or more electrochromic layers 140, a second ITO layer 150, a second buffer layer 160, and a second polycarbonate layer 170.

FIG. 1A further illustrates exemplary thickness and index values for each layer and resulting reflectance values in both table and graph form. As illustrated, it can be seen that the ITO layers may comprise a thickness of about 100 nm; resulting in an average reflectance across the visible spectrum of about 5.7% and a luminous reflection of about 6.5%.

FIGS. 1B and 1C shows graphs illustrating various reflection values as a function of wavelength of the example shown in FIG. 1A.

In the example shown in FIG. 2A, an electronic device 100 may similarly comprise, from bottom to top, a first polycarbonate layer 110, a first buffer layer 120, a first ITO layer 130, one or more electrochromic layers 140, a second ITO layer 150, a second buffer layer 160, and a second polycarbonate layer 170.

FIG. 2A further illustrates exemplary thickness and index values for each layer and resulting reflectance values in both table and graph form. As illustrated, it can be seen that the ITO layers have a thickness which has been increased by about 30% (e.g., from 100 nm to 130 nm) as compared to the example shown in FIGS. 1A-1C.

FIG. 2B includes a graph illustrating reflectance as a function of wavelength of such an example having polycarbonate layers 110, 170 with an index of 1.59, buffer layers 120, 160 having a thickness of 3000 nm and an index of 1.5, ITO layers 130, 150 with an index of 1.9 having a thickness of 130 nm, and one or more optically thick electrochromic layers 140 with an index of 1.5.

As shown in FIGS. 2A and 2B, such an example was found to have 2.4% average reflectance at wavelengths across the visible spectrum and 1.9% luminous reflection.

As reflected in FIGS. 1A-1C and 2A-2B, an increase of the thickness of the ITO layers by about 30% resulted in a reduction of about 58% in reflectance across the visible spectrum and a reduction of about 71% in luminous reflection.

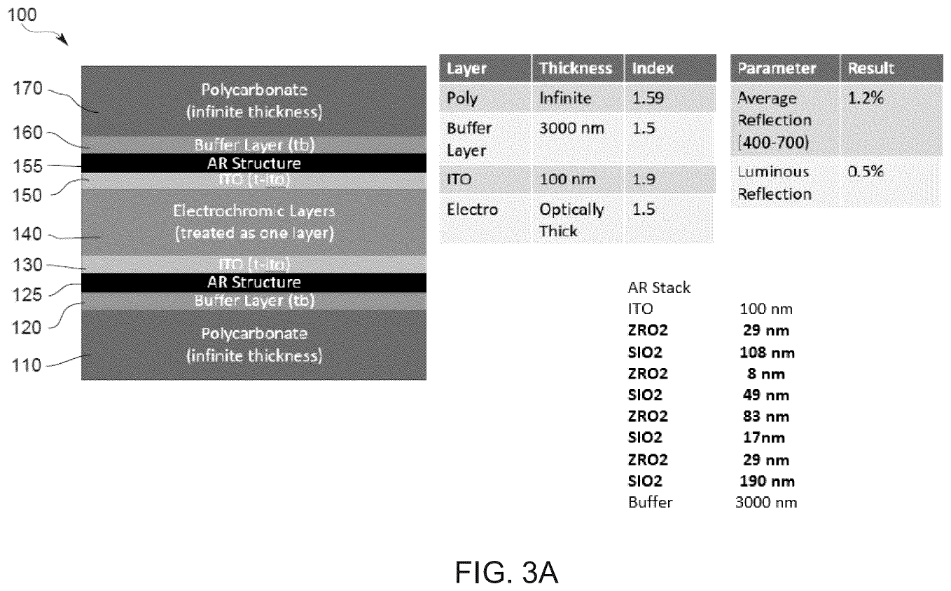

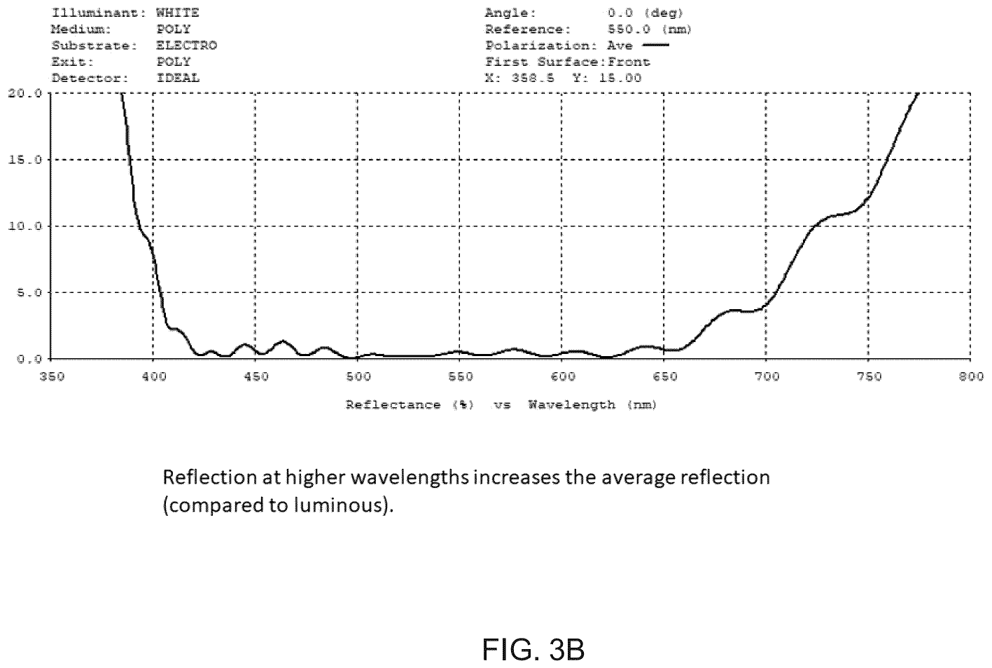

FIGS. 3-8 illustrate examples of an electronic device 100 which include AR layers 125, 155 so as to reduce reflectance without increasing the thickness of the ITO layers. Such examples of an electronic device 100 may comprise, from bottom to top, a first polycarbonate layer 110, a first buffer layer 120, a first AR layer 125, a first ITO layer 130, one or more electrochromic layers 140, a second ITO layer 150, a second AR layer 155, a second buffer layer 160, and a second polycarbonate layer 170.

In the example shown in FIGS. 3A-3B, a graph illustrates reflectance as a function of wavelength of an example having polycarbonate layers 110, 170 with an index of 1.59, buffer layers 120, 160 having a thickness of 3000 nm and an index of 1.5, ITO layers 130, 150 with an index of 1.9 having a thickness of 100 nm, and one or more optically thick electrochromic layers 140 with an index of 1.5.

Continuing to reference FIGS. 3A-3B, the AR layers 125, 155 are each illustrated as comprising alternating layers of zirconium dioxide and silicon dioxide. In the illustrated example, it can be seen that the AR layers 125, 155 may comprise varying thicknesses for each of the alternating layers, including a 190 nm silicon dioxide layer, a 29 nm zirconium dioxide layer, a 17 nm silicone dioxide layer, an 83 nm zirconium dioxide layer, a 49 nm silicone dioxide layer, an 8 nm zirconium dioxide layer, a 108 nm silicone dioxide layer, and a 29 nm zirconium dioxide layer. Thus, the AR layers 125, 155 of the example of FIGS. 3A-3B may comprise a thickness of about 513 nm in total.

As shown in FIGS. 3A-3B, such an example was found to have 1.2% average reflectance at wavelengths along the visible spectrum and 0.5% luminous reflection. It is thus shown that the inclusion of the AR layers 125, 155 comprising alternating layers of zirconium dioxide and silicone dioxide has reduced both average reflectance across the visible spectrum and luminous reflectance as compared to the example shown in FIGS. 1A-1C, which includes the same 100 nm thickness of the ITO layers 130, 150 but does not include any AR layers 125, 155.

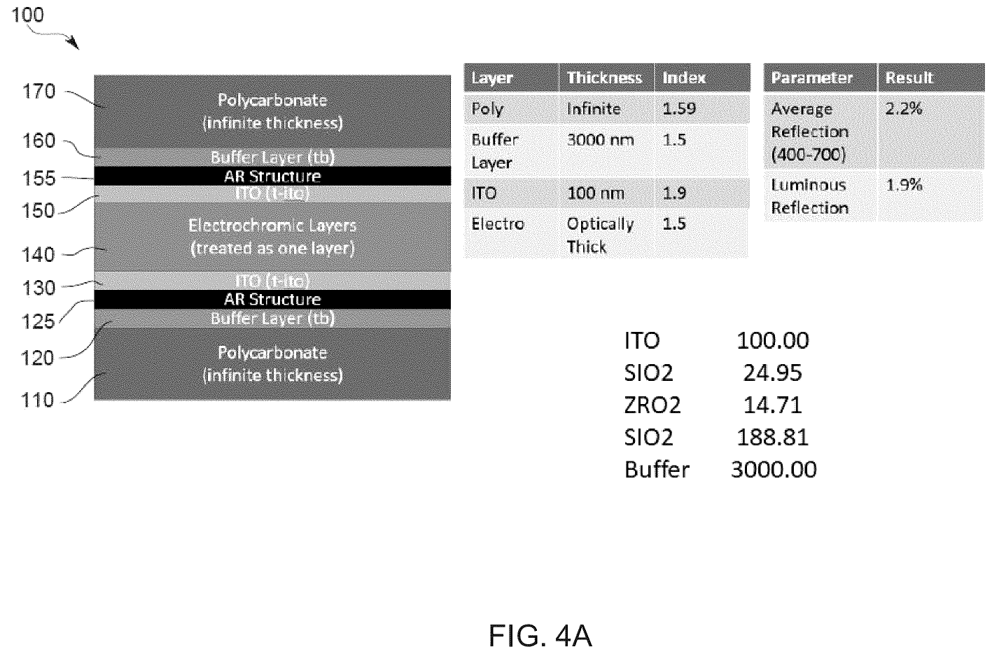

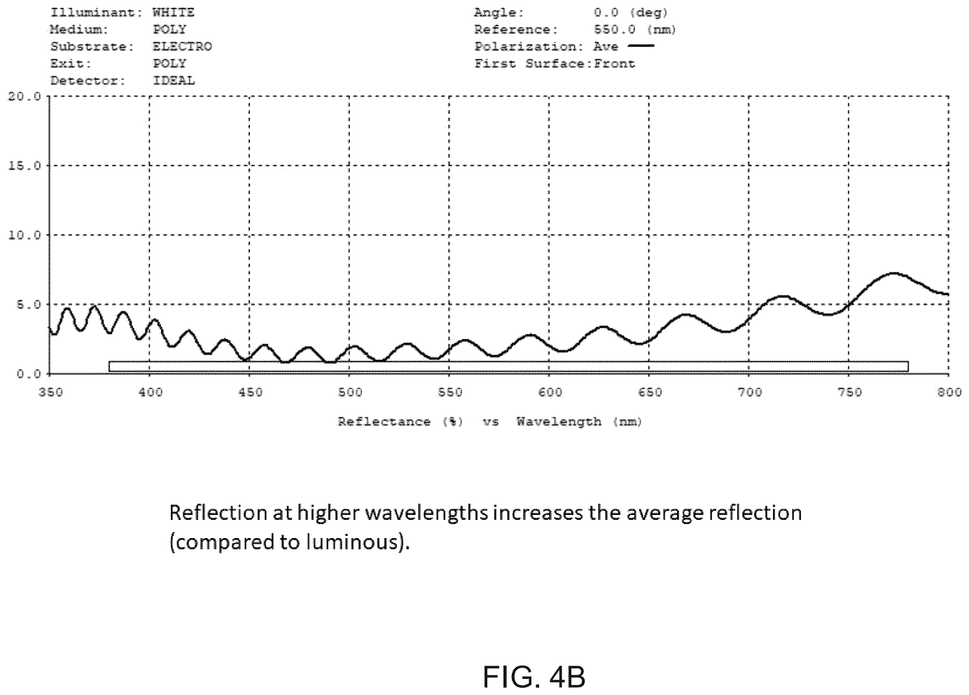

In the example shown in FIGS. 4A-4B, a graph illustrates reflectance as a function of wavelength of an example having polycarbonate layers 110, 170 with an index of 1.59, buffer layers 120, 160 having a thickness of 3000 nm and an index of 1.5, ITO layers 130, 15 with an index of 1.9 having a thickness of 100 nm, and one or more optically thick electrochromic layers 140 with an index of 1.5.

Continuing to reference FIGS. 4A-4B, the AR layers 125, 155 are each illustrated as comprising outer layers of silicone dioxide with a single layer of zirconium dioxide sandwiched therebetween. More specifically, a first silicone dioxide layer may comprise a thickness of about 188.81 nm, a zirconium dioxide layer may comprise a thickness of about 14.71 nm, and a second silicone dioxide layer may comprise a thickness of about 24.95 nm. Thus, the AR layers 125, 155 of the example of FIGS. 4A-4B may comprise a thickness of about 228.47 nm in total.

As shown in FIGS. 4A-4B, such an example was found to have 2.2% average reflectance at wavelengths along the visible spectrum and 1.9% luminous reflection. It is thus shown that the inclusion of the AR layers 125, 155 comprising a pair of silicone dioxide layers positioned on either side of a central zirconium dioxide layer has reduced both average reflectance across the visible spectrum and luminous reflectance as compared to the example shown in FIGS. 1A-1C, which includes the same 100 nm thickness of the ITO layers 130, 150 but does not include any AR layers 125, 155.

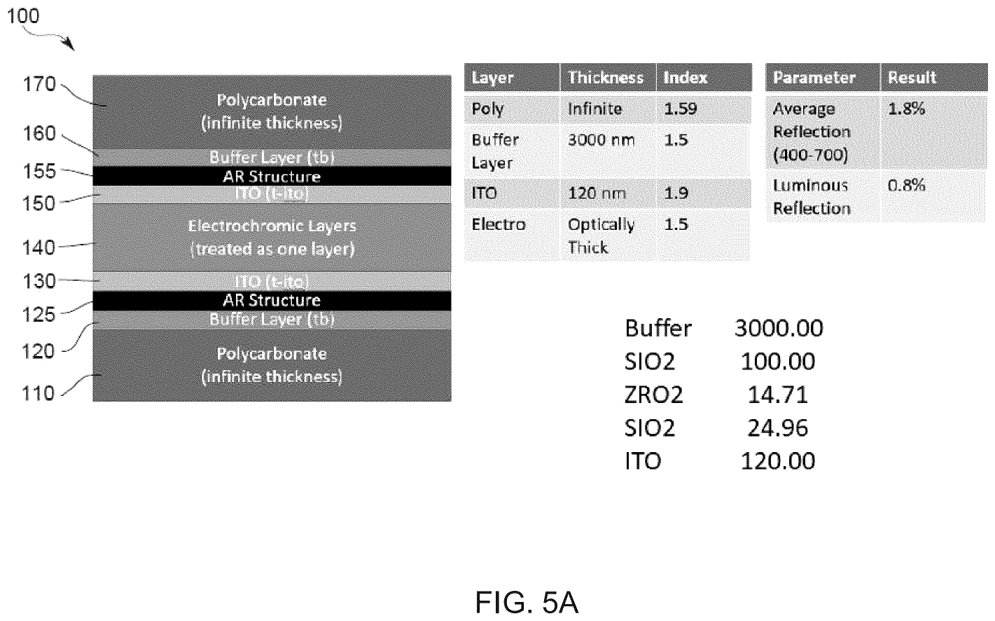

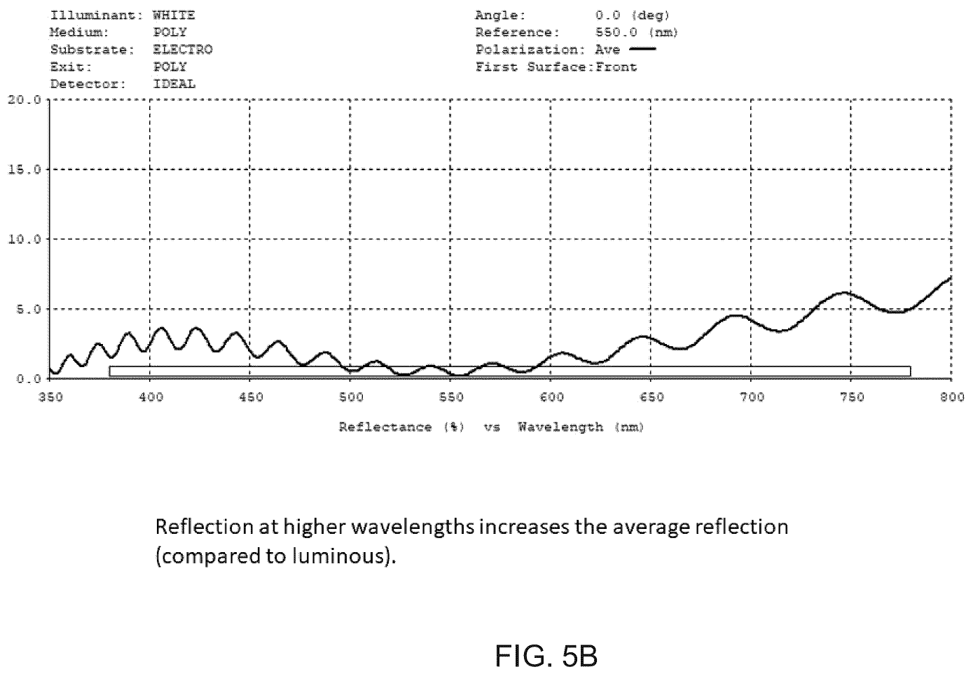

In the example shown in FIGS. 5A-5B, a graph illustrates reflectance as a function of wavelength of an example having polycarbonate layers 110, 170 with an index of 1.59, buffer layers 120, 160 having a thickness of 3000 nm and an index of 1.5, ITO layers 130, 150 with an index of 1.9 having a an increased thickness of 120 nm, and one or more optically thick electrochromic layers 140 with an index of 1.5.

Continuing to reference FIGS. 5A-5B, the AR layers 125, 155 are each illustrated as comprising outer layers of silicone dioxide with a single layer of zirconium dioxide sandwiched therebetween. More specifically, a first silicone dioxide layer may comprise a thickness of about 24.96 nm, a zirconium dioxide layer may comprise a thickness of about 14.71 nm, and a second silicone dioxide layer may comprise a thickness of about 100 nm. Thus, the AR layers 125, 155 of the example of FIGS. 5A-5B may comprise a thickness of about 139.67 nm in total.

It should thus be appreciated that the example of FIGS. 5A-5B is similar to that of FIGS. 4A-4B, except with a 20% increased thickness of the ITO layers 130, 150. As shown in FIGS. 5A-5B, such an example was found to have 1.8% average reflectance at wavelengths across the visible spectrum and 0.8% luminous reflection. It is thus shown that the inclusion of the AR layers 125, 155, comprising a pair of silicone dioxide layers positioned on either side of a central zirconium dioxide layer, and a 20% increase in the thickness of the ITO layers 130, 150, has reduced both average reflectance across the visible spectrum and luminous reflectance as compared to the example shown in FIGS. 1A-1C, which includes a 100 nm thickness of the ITO layers 130, 150 but does not include any AR layers 125, 155.

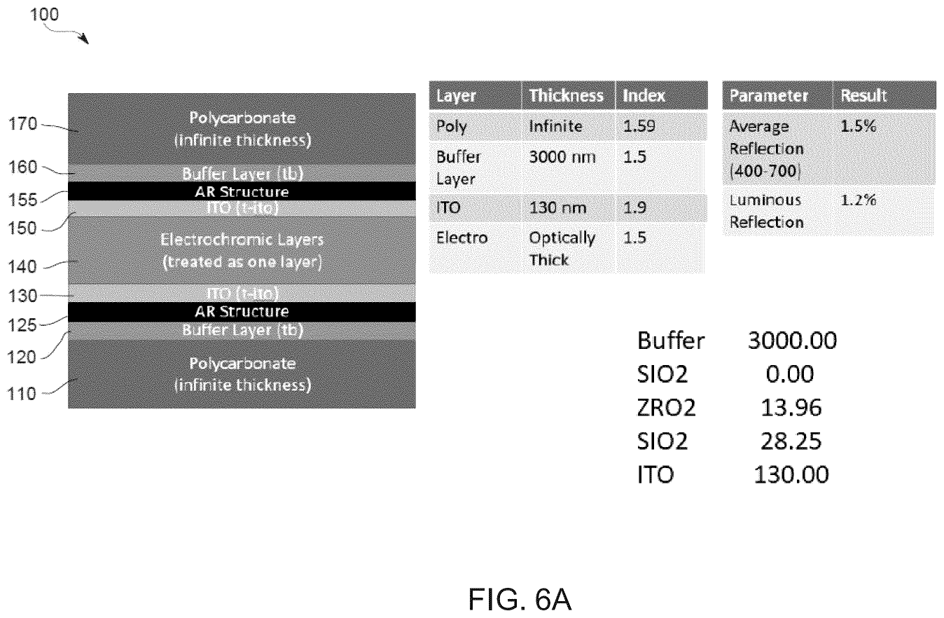

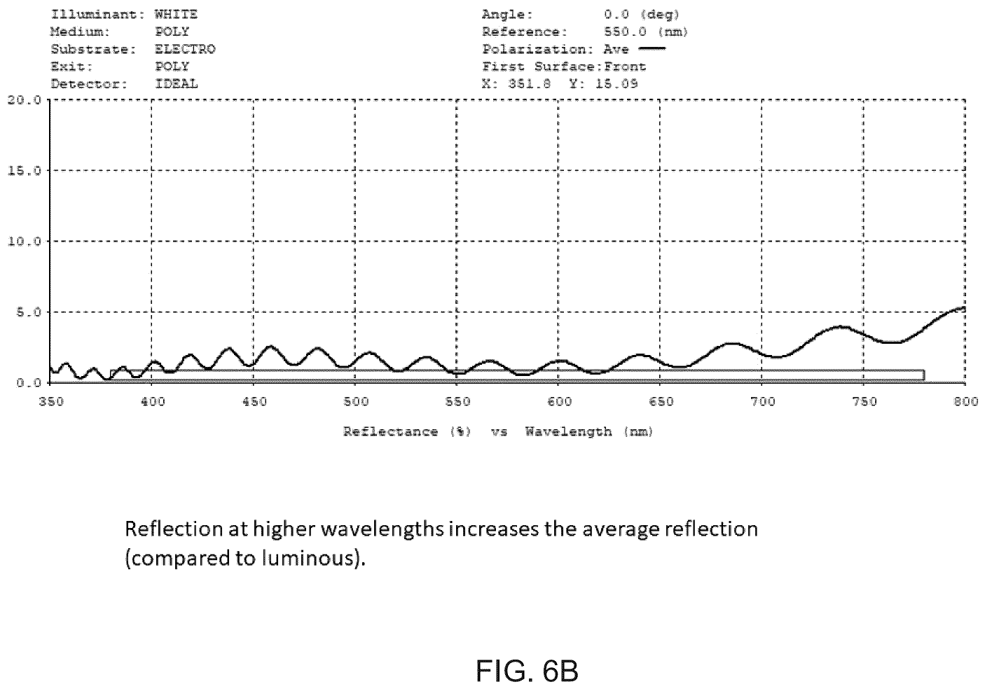

In the example shown in FIGS. 6A-6B, a graph illustrates reflectance as a function of wavelength of an example having polycarbonate layers 110, 170 with an index of 1.59, buffer layers 120, 160 having a thickness of 3000 nm and an index of 1.5, ITO layers 130, 150 with an index of 1.9 having a thickness of 130 nm, and one or more optically thick electrochromic layers 140 with an index of 1.5.

Continuing to reference FIGS. 6A-6B, the AR layers 125, 155 are each illustrated as comprising a single silicone dioxide layer comprising a thickness of about 28.25 nm and a single zirconium dioxide layer comprising a thickness of about 13.96 nm. Thus, the AR layers 125, 155 of the example of FIGS. 6A-6B may comprise a thickness of about 42.21 nm in total.

As shown in FIGS. 6A-6B, such an example was found to have 1.5% average reflectance at wavelengths across the visible spectrum and 1.2% luminous reflection. It is thus shown that the inclusion of the AR layers 125, 155 comprising a single layer each of silicon dioxide and zirconium dioxide has reduced both average reflectance across the visible spectrum and luminous reflectance as compared to the example shown in FIGS. 2A-2B, which includes the same 130 nm thickness of the ITO layers 130, 150 but does not include any AR layers 125, 155.

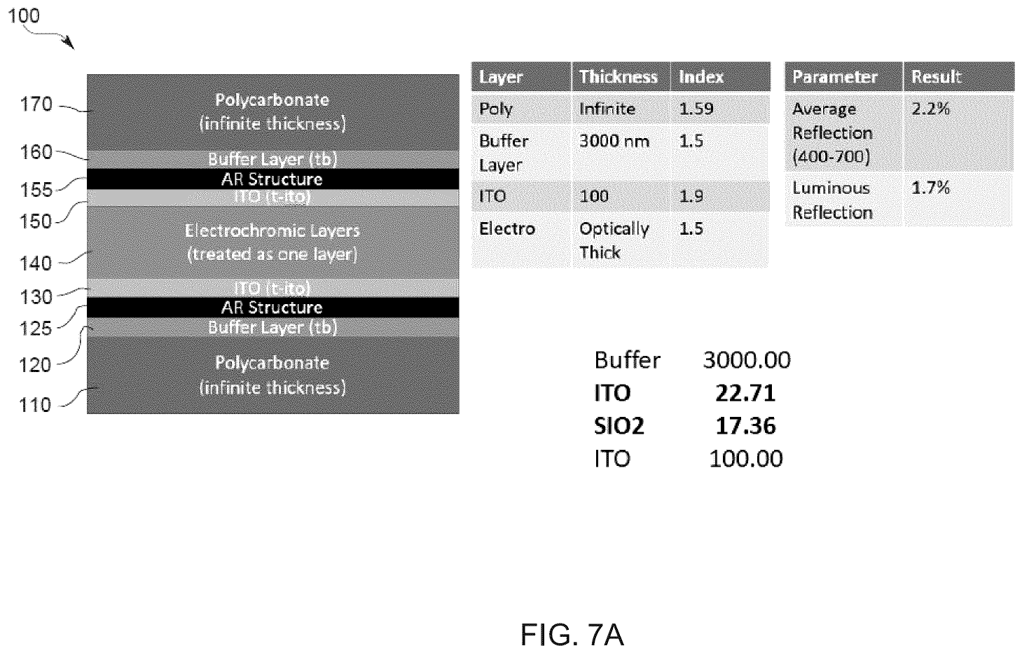

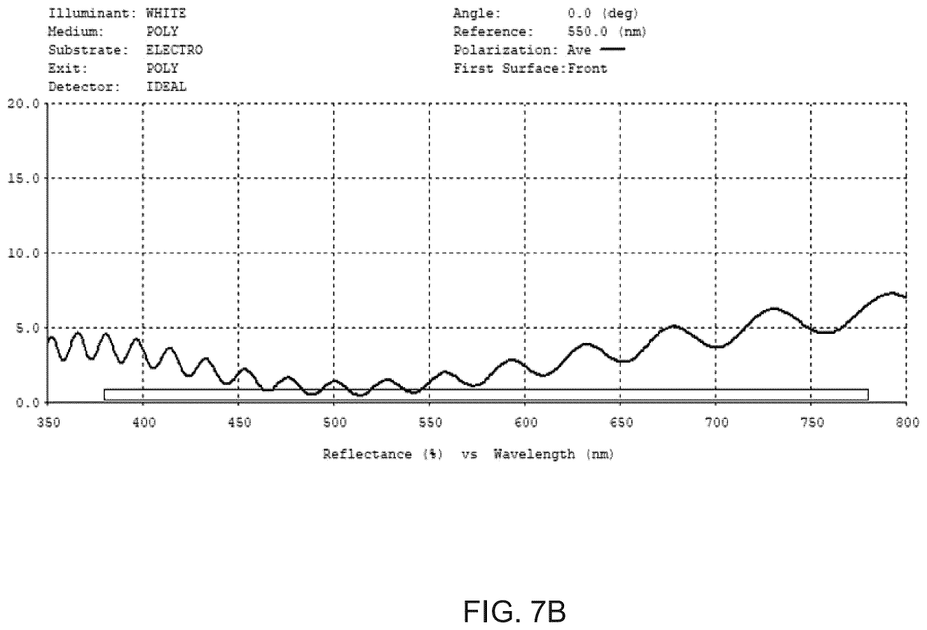

In the example shown in FIGS. 7A-7B, a graph illustrates reflectance as a function of wavelength of an example having polycarbonate layers 110, 170 with an index of 1.59, buffer layers 120, 160 having a thickness of 3000 nm and an index of 1.5, ITO layers 130, 150 with an index of 1.9 having a thickness of 100 nm, and one or more optically thick electrochromic layers 140 with an index of 1.5.

Continuing to reference FIGS. 7A-7B, the AR layers 125, 155 are each illustrated as comprising a single silicone dioxide layer comprising a thickness of about 17.36 nm and a single ITO layer comprising a thickness of about 22.71 nm. Thus, the AR layers 125, 155 of the example of FIGS. 7A-7B may comprise a thickness of about 40.07 nm in total.

As shown in FIGS. 7A-7B, such an example was found to have 2.2% average reflectance at wavelengths across the visible spectrum and 1.7% luminous reflection. It is thus shown that the inclusion of the AR layers 125, 155 comprising a single layer each of zirconium dioxide and silicone dioxide has reduced both average reflectance across the visible spectrum and luminous reflectance as compared to the example shown in FIGS. 1A-1C, which includes the same 100 nm thickness of the ITO layers 130, 150 but does not include any AR layers 125, 155.

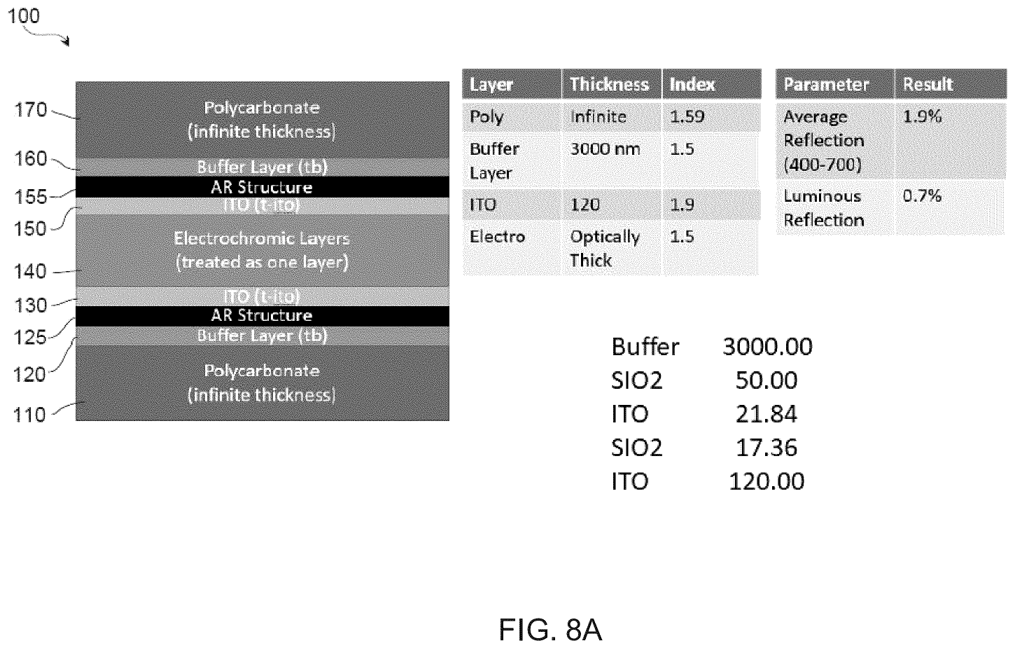

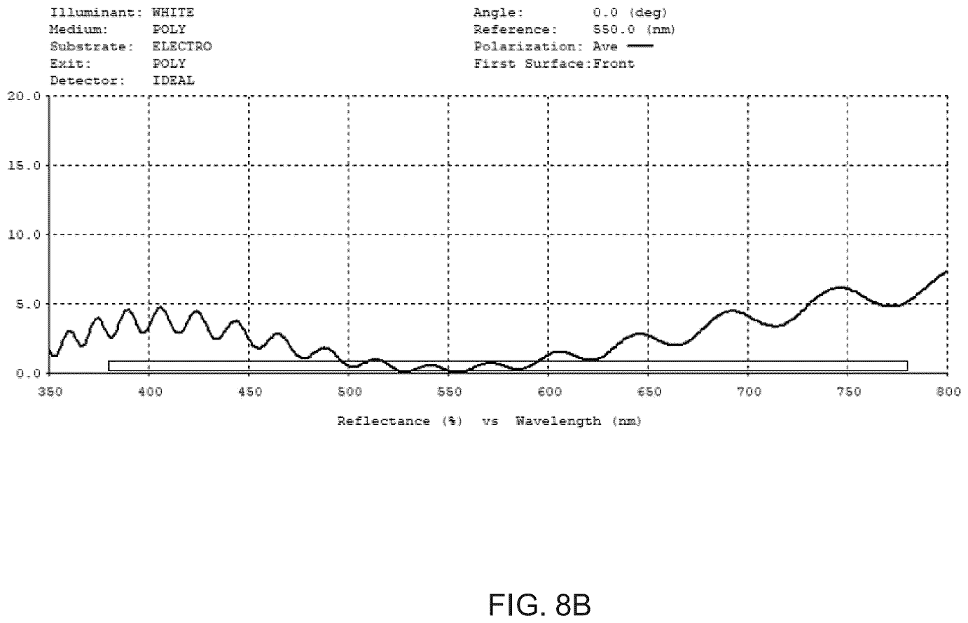

In the example shown in FIGS. 8A-8B, a graph illustrates reflectance as a function of wavelength of an example having polycarbonate layers 110, 170 with an index of 1.59, buffer layers 120, 160 having a thickness of 3000 nm and an index of 1.5, ITO layers 130, 150 with an index of 1.9 having a thickness of 120 nm, and one or more optically thick electrochromic layers 140 with an index of 1.5.

Continuing to reference FIGS. 8A-8B, the AR layers 125, 155 are each illustrated as comprising outer layers of silicone dioxide with a single layer of zirconium dioxide sandwiched therebetween. More specifically, a first silicone dioxide layer may comprise a thickness of about 17.36 nm, a zirconium dioxide layer may comprise a thickness of about 21.84 nm, and a second silicone dioxide layer may comprise a thickness of about 50 nm. Thus, the AR layers 125, 155 of the example of FIGS. 8A-8B may comprise a thickness of about 89.2 nm.

As shown in FIGS. 8A-8B, such an example was found to have 1.9% average reflectance at wavelengths across the visible spectrum and 0.7% luminous reflection; showing a reduction in both values as compared to both 100 nm and 130 nm ITO layer 130, 150 thicknesses without any AR layers 125, 155 as shown in 1A-1C and 2A-2B.

It should be appreciated that the manner by which the electronic device 100 is fabricated may vary in different examples and thus should not be limited in scope. Any method known in the art for constructing multi-layer optical lenses may be utilized. With respect to the fabrication of the AR layers 125, 155, it should be appreciated that various methods known for formation of a rugate filter, including sputtering, chemical vapor deposition, and the like, may be utilized as previously discussed.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

1. An electronic ophthalmic lens, comprising:
a first polycarbonate layer;
a second polycarbonate layer;
an electrochromic layer between the first polycarbonate layer and the second polycarbonate layer;
a first ITO layer between the first polycarbonate layer and the electrochromic layer; and
a first AR layer between the first polycarbonate layer and the first ITO layer.

2. The electronic ophthalmic lens of claim 1, wherein the first AR layer is comprised of silicone dioxide.

3. The electronic ophthalmic lens of claim 1, wherein the first AR layer is comprised of zirconium dioxide.

4. The electronic ophthalmic lens of claim 1, wherein the first AR layer has a thickness which is less than a thickness of the first ITO layer.

5. The electronic ophthalmic lens of claim 1, wherein a thickness of the first ITO layer is between 100 nm and 130 nm.

6. The electronic ophthalmic lens of claim 1, further comprising a second ITO layer between the second polycarbonate layer and the electrochromic layer.

7. The electronic ophthalmic lens of claim 6, further comprising a second AR layer between the second polycarbonate layer and the second ITO layer.

8. The electronic ophthalmic lens of claim 7, wherein the first AR layer and the second AR layer each comprise silicone dioxide and zirconium dioxide.

9. The electronic ophthalmic lens of claim 7, further comprising a first buffer layer between the first polycarbonate layer and the first ITO layer and a second buffer layer between the second polycarbonate layer and the second ITO layer.

10. The electronic ophthalmic lens of claim 9, wherein the first buffer layer and the second buffer layer are each comprised of a siloxane hardcoat.

11. The electronic ophthalmic lens of claim 1, wherein the first AR layer comprises a first silicone dioxide layer, a second silicone dioxide layer, and a zirconium dioxide layer between the first and second silicone dioxide layers.

12. The electronic ophthalmic lens of claim 1, wherein the first AR layer comprises alternating layers of silicone dioxide and zirconium dioxide.

13. An electronic ophthalmic lens, comprising:
a first polycarbonate layer;
a second polycarbonate layer;
an electrochromic layer between the first polycarbonate layer and the second polycarbonate layer;
a first ITO layer between the first polycarbonate layer and the electrochromic layer;
a first AR layer between the first polycarbonate layer and the first ITO layer;
a second ITO layer between the second polycarbonate layer and the electrochromic layer; and
a second AR layer between the second polycarbonate layer and the second ITO layer.

14. The electronic ophthalmic lens of claim 13, further comprising a first buffer layer between the first AR layer and the first polycarbonate layer.

15. The electronic ophthalmic lens of claim 14, further comprising a second buffer layer between the second AR layer and the second polycarbonate layer.

16. The electronic ophthalmic lens of claim 15, wherein each of the first and second buffers layers is comprised of a siloxane hardcoat.

17. The electronic ophthalmic lens of claim 13, wherein the first ITO layer and the second ITO layer each comprise silicone dioxide.

18. The electronic ophthalmic lens of claim 17, wherein the first ITO layer and the second ITO layer each comprise zirconium dioxide.

19. The electronic ophthalmic lens of claim 13, wherein the first ITO layer and the second ITO layer each comprise alternating layers of silicone dioxide and zirconium dioxide.

20. The electronic ophthalmic lens of claim 13, wherein the first ITO layer and the second ITO layer each comprise a first silicone dioxide layer, a second silicone dioxide layer, and a zirconium dioxide layer between the first and second silicone dioxide layers.
